(19) United States
(12) Patent Application Publication
(10) Pub. No.: US 2004/0098321 A1
(43) Pub. Date: May 20, 2004

(54) Integrated inventory management system and method

(76) Inventor: ZheXiong Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,434

(22) Filed: Dec. 30, 2002

(30) Foreign Application Priority Data
Nov. 15, 2002 (TW) 91133443

(51) Int. Cl. G06F 17/60

(52) U.S. Cl. 705/28

(57) ABSTRACT

An integrated inventory management system includes a database server (4), and a website server (2). The database server includes a database (40) for storing basic information. The website server includes a material distribution unit (23) for distributing material, and generating material distribution records when current inventory meets material requirements, and for calculating requisition quantities and generating purchase requisition bills when current inventory does not meet material requirements; a purchase unit (24) for calculating purchase quantities according to purchase requisition bills and current inventory, and generating purchase orders and purchase records; a stock receipt unit (25) for accepting delivered material and generating stock receipt records and material acceptance bills; a data reconciliation unit (27) for carrying out data reconciliation operations according to purchase orders and delivery bills, and generating data reconciliation records; and a decision analysis unit (28) for analyzing purchase records, inventory data and data reconciliation records to generate different trend graphs.

### BACKGROUND OF THE INVENTION

1. Field of the Invention

The present invention relates to inventory management systems and methods, and particularly to an inventory management system and method for integrating operations of material purchase, material distribution and stock receipt.

2. Background of the Invention

Nowadays for manufacturers, inventory costs accounts for a large percentage of total turnover. Controlling inventory more efficiently cuts down inventory costs, and is an effective measure for increasing a company's profits. Many scholars have been engaged in the research of inventory management, which has developed from the Reorder Point System established in the 1940s to today's Enterprise Resource Planning (ERP). Most methods for managing inventory focus on how to determine a standard stock level, a safe stock level, and an economical ordering quantity. Popular inventory control methods include the Two-Bin System, the Fixed-Quantity System, the Fixed-Interval System, and the Min-Max System. The art of managing inventory are disclosed in patents such as U.S. Pat. No. 6,021,396 issued on Feb. 1, 2000 and entitled Method to Provide Sensitivity Information for (R, s, S) Inventory System with Back-Ordered Demand. This patent provides a particular (R, s, S) system to optimize inventory structure, through which users can obtain sensitivity information of average reorder quantity and the safety stock level by analyzing two key variables: s (purchase quantity) and S (safe stock level).

In a broad sense, inventory management not only includes inventory controlling operations, but also operations of material distribution, material purchase and stock receipt. No known inventory management systems provide satisfactory means for integrating those operations. In addition, existing inventory management systems generally do not provide analysis of previous records such as purchase quantity and material price. This can result in incorrect purchase quantities and additional loss. Thus, a system and method for managing inventory which overcomes the above-mentioned problems is desired.

### SUMMARY OF THE INVENTION

Accordingly, a main objective of the present invention is to provide an integrated inventory management system and method, whereby users can integrate material purchase, stock receipt, material distribution and data reconciliation operations to make inventory management more efficient.

Another objective of the present invention is to provide an integrated inventory management system and method, whereby users can analyzes previous purchase records and data reconciliation records, and generate decision analysis data to help make purchasing decisions.

A further objective of the present invention is to provide an integrated inventory management system that can automatically check current inventory at regular intervals, and generate alarm messages to advise purchasing officers to purchase material when the current inventory does not meet material requirements.

To accomplish the above objectives, an integrated inventory management system in accordance with a preferred embodiment comprises a database server including a database for storing basic information including supplier information, material information, material requirement information, purchase requisition bills, stock receipt records, inventory data, data reconciliation records and material distribution records, and a website server for users logging on a website to purchase material online. The database server is connected to a production management system of a company for obtaining material requirement information, and to a plurality of supplier information systems for transmitting purchase orders to corresponding suppliers. The website server comprises: a material distribution unit for distributing material to relevant production departments, and generating material distribution records when current inventory is adequate according to material requirement information, and for calculating requisition quantities and generating purchase requisition bills when current inventory is not adequate; a purchase unit for calculating purchase quantities according to purchase requisition bills and current inventory, and generating purchase orders and purchase records; a stock receipt unit for accepting delivered material and generating stock receipt records and material acceptance bills; a data reconciliation unit for carrying out data reconciliation operations according to purchase orders and delivery bills, and generating data reconciliation records; a purchase return unit for returning the material to suppliers, and generating purchase return records; an information search unit for searching inventory data, purchase records and data reconciliation records; and a decision analysis unit for analyzing purchase records, inventory data and data reconciliation records to generate different trend graphs.

Further, the present invention provides an integrated inventory management method. The method comprises the steps of: (a) determining whether current inventory is adequate according to material requirement information; (b) distributing material, and generating distribution records when the current inventory meets the material requirements, or calculating requisition quantities to generate purchase requisition bills when the current inventory does not meet the material requirements; (c) calculating purchase quantities according to the purchase requisition bills and the current inventory, and generating purchase orders and purchase records; (d) accepting material delivered by suppliers and generating stock receipt records and material acceptance bills, if the delivery bills coincide with the purchase orders and a quality of the material is satisfactory as required by one or more requisitioning departments; (e) reconciling data according to the purchase orders and the material acceptance bills, and generating data reconciliation records.

Other objects, advantages and novel features of the present invention will be drawn from the following detailed description with reference to the attached drawings, in which:

### BRIEF DESCRIPTION OF THE DRAWINGS

FIG. 1 is a diagram of hardware configuration of an integrated inventory management system in accordance with a preferred embodiment of the present invention;

FIG. 2 is a block diagram of main function units of a website server of the system of FIG. 1;

FIG. 3 is a block diagram of main function units of a decision analysis unit of the website server of FIG. 2; and

FIG. 4 is a flowchart of a preferred method for implementing the integrated inventory management system of the present invention.

### DETAILED DESCRIPTION OF THE INVENTION

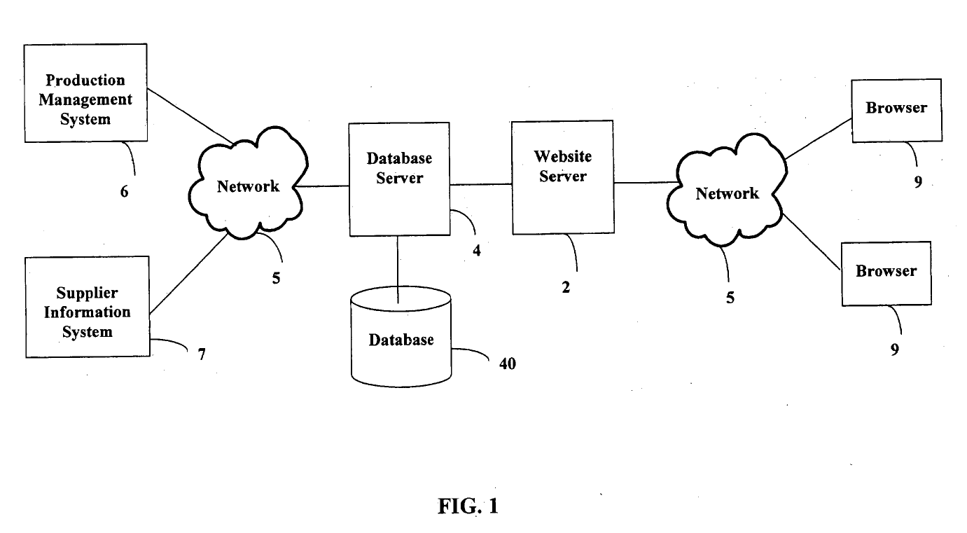

FIG. 1 is a block diagram of hardware configuration of an integrated inventory management system in accordance with a preferred embodiment of the present invention. Users such as purchasing officers, material receiving operators, material distribution operators, accounts clerks and relevant managers are located at various computer terminals each having a browser 9. The browsers 9 are connected with a website server 2 via a communications network 5. Thus the users can log on the website server 2, carry out necessary operations, and obtain decision analysis data. Operations include material purchase, material receipt, material distribution, and data reconciliation. The decision analysis data include purchase alarm messages, inventory alarm messages, material price trend graphs and cost trend graphs. Each browser 9 can be Microsoft Internet Explorer or Netscape Navigator. The network 5 can be the Internet or an intranet.

The website server 2 is connected to a database server 4. The database server 4 comprises a database 40 for storing basic information including supplier information, material information, purchase requisition bills, stock receipt records, inventory data, data reconciliation records and material distribution records.

The database server 4 is connected to a production management system 6 and a plurality of supplier information systems 7 (only one shown) via the network 5. The production management system 6 is an enterprise information system for generating material requirement information according to production planning, and for transmitting the material requirement information to the database server 4.

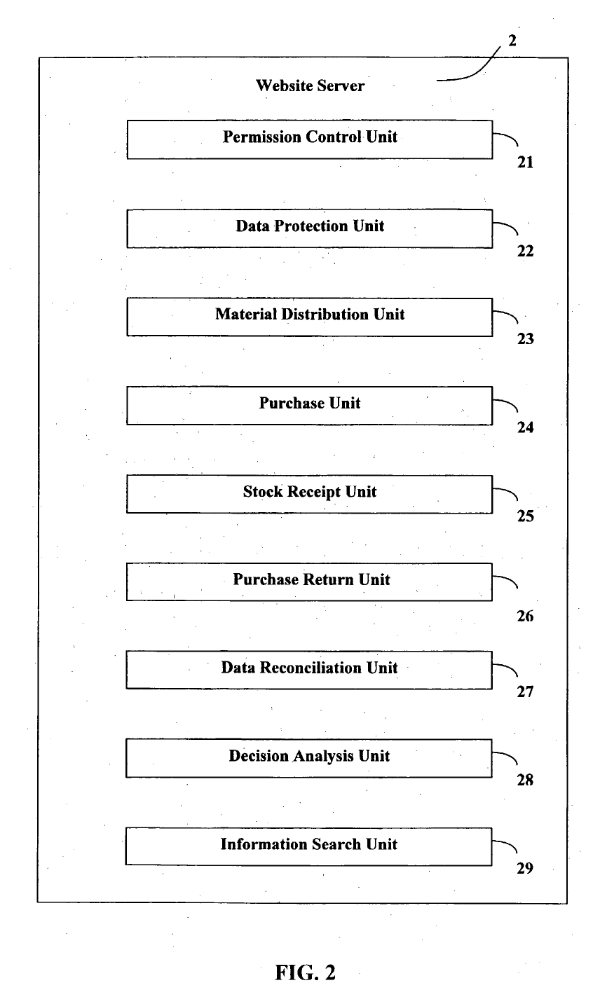

FIG. 2 is a schematic diagram of main function units of the website server 2. The website server 2 includes a permission control unit 21, a data protection unit 22, a material distribution unit 23, a purchase unit 24, a stock receipt unit 25, a purchase return unit 26, a data reconciliation unit 27, a decision analysis unit 28, and an information search unit 29. The permission control unit 21 restricts a scope of information that can be obtained by each user, to ensure confidentiality and security of the information system. When a user logs on the website server 2, the permission control unit 21 first validates the user's ID, then generates an information scope that can be accessed by the user. The data protection unit 22 protects supplier information and material information, and has the functions of adding, deleting or modifying supplier information and material information. Basic supplier information includes each supplier's name, registered number, address, contact telephone number, and material supplied by the supplier. Basic information on each material includes name, registered number, purchase lead time, standard average price, and safe stock level.

The material distribution unit 23 determines whether current inventory is adequate according to material requirement information. If the current inventory meets the material requirements, the material distribution unit 23 generates material distribution bills according to the material requirement information, and deducts the material requirements from the current inventory. Otherwise, the material distribution unit 23 generates purchase requisition bills. Information in a purchase requisition bill includes a material name, a material number, a requisition quantity, requisitioning departments, and date required. The requisition quantity is obtained by deducting the balance of current inventory from the requirements, and then adding the safe stock level.

The purchase unit 24 determines purchase quantities of a material according to purchase requisition bills, generates purchase orders, and transmits the purchase orders to corresponding suppliers. Information in a purchase order includes a material name, supplier number, supplier name, purchase quantity, purchase price, and date required.

The stock receipt unit 25 checks purchase orders against delivery bills that are provided by a supplier when material is delivered, and verifies a quality of received material. If the delivery bills coincide with the purchase orders, and the quality of the material is satisfactory, the stock receipt unit 25 accepts the material and generates stock receipt records and material acceptance bills. Information in a stock receipt record includes a material name, a material number, a material quantity, a supplier name, a date received, and a responsible stock receipt operator. The material acceptance bills are proof of delivery, whereby accounts clerks can perform data reconciliation operations. If the delivery bills does not coincide with the purchase orders, or if the quality of the material is not satisfactory, the purchase return unit 26 returns the material to the supplier, and generates purchase return records and purchase return bills.

The data reconciliation unit 27 is used for accounts clerks to carry out data reconciliation operations according to purchase orders and delivery bills, and for generating data reconciliation records.

The decision analysis unit 28 analyzes purchase records, inventory data and data reconciliation records stored in the database 40, and generates corresponding decision analysis data. Said data includes purchase quantity trend graphs, inventory alarm data, material price trend graphs, and purchase cost trend graphs.

The information search unit 29 provides different searching methods for corresponding operators to search relevant data. For instance, the integrated inventory management system in the preferred embodiment of the present invention provides means for querying inventory data, purchase records, data reconciliation records and other relevant data.

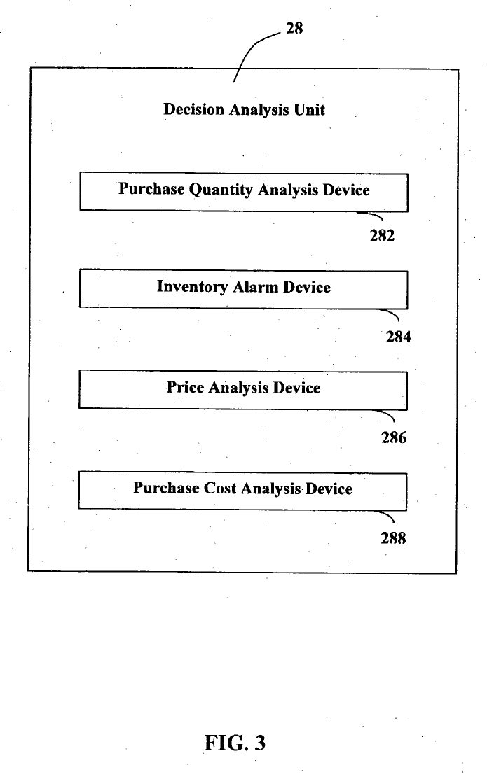

FIG. 3 is a schematic diagram of main function units of the decision analysis unit 28 of the website server 2. The decision analysis unit 28 comprises a purchase quantity analysis device 282, an inventory alarm device 284, a price analysis device 286, and a purchase cost analysis device 288. The purchase quantity analysis device 282 analyzes purchase records stored in the database 40 to generate purchase quantity trend graphs of different departments at different times. The inventory alarm device 284 automatically checks current inventory at preset times of each day, and generates alarm messages to advise relevant purchasing officers when the current inventory of a material is less than the safe stock level. The price analysis device 286 analyzes purchase records stored in the database 40, and generates price trend graphs of different materials at different times. The purchase cost device 288 analyzes purchase records and data reconciliation records stored in the database 40, and generates purchase cost trend graphs of different materials at different times. Each purchase cost is equal to a purchase quantity of the material multiplied by its unit cost.

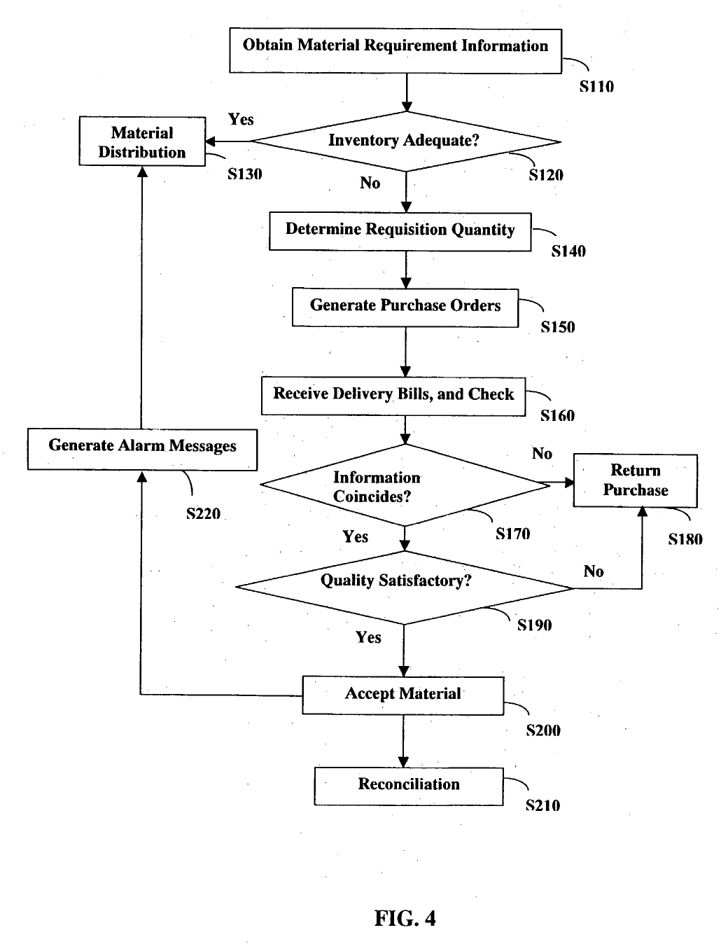

FIG. 4 is a flowchart of a preferred method for implementing the integrated inventory management system of the present invention.

In step S110, the database server 4 obtains material requirement information from the production management system 6, and stores the information in the database 40. Material distribution operators can obtain the material requirement information through the material distribution unit 23.

In step S120, operators determine whether current inventory meets the material requirements. That is, whether current inventory minus the safe stock level of the material is not less than the material requirements.

If the current inventory of the material meets the requirements, in step S130, material distribution operators generate material distribution bills according to the material requirement information. The material distribution unit 23 generates material distribution records according to the material distribution bills, and stores the material distribution records in the database 40. Information in a material distribution record includes a material name, a material number, a material quantity, requisitioning departments, a distribution date, and corresponding operators. Thereupon, the material requirement information is set as managed, and the procedure is ended.

In step S140, if the current inventory of the material does not meet the material requirements, the material distribution unit 23 calculates a requisition quantity, and generates purchase requisition bills. Thereupon, the material requirement information is set as unmanaged.

In step S150, purchasing officers obtain the purchase requisition bills through the purchase unit 24, generate purchase quantity trend graphs, material price trend graphs and purchase cost trend graphs through the decision analysis unit 28, calculate a purchase quantity according to the trend graphs, and generate purchase orders. The purchase orders are stored in the database 40, and transmitted to corresponding suppliers through the network 5 by means of email or electronic data interchange (EDI).

When the material is delivered, in step S160, stock receipt operators receive delivery bills from the suppliers, and check the delivery bills against the purchase orders stored in the database 40 via the stock receipt unit 25.

In step S170, the stock receipt unit 25 determines whether the delivery bills coincide with the purchase orders regarding delivery quantity, delivery time, material name and other information.

If the delivery bills do not coincide with the purchase orders, in step S180, the stock receipt operators reject the material via the purchase return unit 26, and generate purchase return records. The purchase return records are stored in the database 40.

If the delivery bills coincide with the purchase orders, in step S190, the stock receipt operators check a quality of the material against a quality required by the requisitioning departments through the stock receipt unit 25.

If the quality of the material is not satisfactory, the procedure proceeds to step S180 as described above.

If the quality of the material is satisfactory, in step S200, the stock receipt operators accept the material, and generate stock receipt records and material acceptance bills via the stock receipt unit 25. The stock receipt records are stored in the database 40.

Thereupon, in step S220, the integrated inventory management system generates alarm messages to advise material distribution operators that the material requirement information set as unmanaged in step S140 is now ready to be set as managed, by way of the material distribution operators proceeding according to step S130 as described above.

Furthermore, in step S210, accounts clerks obtain the stock receipt records via the stock receipt unit 25, and check the material acceptance bills and the purchase orders against the stock receipt records. If the stock receipt records coincide with the material acceptance bills and the purchase orders, the accounts clerks generate data reconciliation records, and store the data reconciliation records in the database 40.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. An integrated inventory management system for integrating operations of material purchase, material distribution, stock receipt and data reconciliation, the system comprising:
a database server including a database for storing supplier information, material information, material requirement information, purchase requisition bills, stock receipt records, inventory data, data reconciliation records and material distribution records; and
a website server comprising:
a material distribution unit for distributing material and generating material distribution records when current inventory meets material requirements, and for calculating a requisition quantity and generating purchase requisition bills when current inventory does not meet material requirements;
a purchase unit for calculating a purchase quantity according to purchase requisition bills and current inventory, and generating purchase orders and purchase records;
a stock receipt unit for accepting delivered material and generating stock receipt records and material acceptance bills; and
a data reconciliation unit for carrying out data reconciliation operations according to purchase orders and delivery bills, and generating data reconciliation records.

2. The system according to claim 1, wherein the database server is connected to a production management system of a company through a network for obtaining material requirement information.

3. The system according to claim 1, wherein the database server is connected to a plurality of supplier information systems through the network for transmitting purchase orders to corresponding suppliers.

4. The system according to claim 1, wherein the website server further comprises a purchase return unit for returning delivered material that is deemed unsatisfactory, and for generating purchase return records.

5. The system according to claim 1, wherein the website server further comprises an information search unit for searching inventory data, purchase records and data reconciliation records.

6. The system according to claim 1, wherein the website server further comprises a decision analysis unit for analyzing purchase records, inventory data and data reconciliation records to generate decision analysis data.

7. The system according to claim 6, wherein the decision analysis data include purchase quantity trend graphs, inventory alarm messages, material price trend graphs and purchase cost trend graphs.

8. The system according to claim 6, wherein the decision analysis unit comprises a purchase quantity analysis device for analyzing purchase records to generate purchase quantity trend graphs of different departments at different times.

9. The system according to claim 6, wherein the decision analysis unit further comprises an inventory alarm device for automatically checking current inventory at regular intervals, and generating alarm messages to advise relevant purchasing officers when the current inventory of the material is less than a safe stock level.

10. The system according to claim 6, wherein the decision analysis unit further comprises a price analysis device for analyzing purchase records, and generating price trend graphs of different materials at different times.

11. The system according to claim 6, wherein the decision analysis unit further comprises a purchase cost analysis device for analyzing purchase records and data reconciliation records to generate purchase cost trend graphs of different materials at different times.

12. An integrated inventory management method for integrating operations of material purchase, material distribution, stock receipt and data reconciliation, the method comprising the steps of:
(a) determining whether current inventory meets material requirements according to material requirement information;
(b) distributing material, and generating distribution records when the current inventory meets the material requirements, or calculating requisition quantities to generate purchase requisition bills when the current inventory does not meet the material requirements;
(c) calculating purchase quantities according to the purchase requisition bills and the current inventory, and generating purchase orders and purchase records;
(d) accepting material delivered by suppliers and generating stock receipt records and material acceptance bills, if the delivery bills coincide with the purchase orders and a quality of the material is satisfactory as required by one or more requisitioning departments; and
(e) reconciling data according to the purchase orders and the material acceptance bills, and generating data reconciliation records.

13. The method according to claim 12, wherein step (a) further comprises the step of obtaining material requirement information from a production management system.

14. The method according to claim 12, wherein step (b) further comprises the steps of:
(b1) analyzing purchase records to generate purchase quantity trend graphs of different departments at different times;
(b2) analyzing purchase records to generate price trend graphs of different materials at different times; and
(b3) analyzing purchase records and data reconciliation records to generate purchase cost trend graphs of different materials at different times.

15. The method according to claim 12, wherein step (c) further comprises the step of transmitting the purchase orders to corresponding suppliers through a communications network.

16. The method according to claim 12, wherein step (d) further comprises the steps of:
(d1) generating alarm messages to advise material distribution operators of the accepted material; and
(d2) returning the material to the supplier and generating purchase return records, if the delivery bills do not coincide with the purchase orders, or if the quality of the material is not satisfactory.

17. An integrated inventory management method for integrating operations of material purchase, material distribution, stock receipt and data reconciliation, the method comprising the steps of:
(a) receiving material requirements;
(b) distributing material and generating distribution records if a current inventory meets material requirements, or calculating purchase quantities according to the current inventory if the current inventory does not meet material requirements;
(c) generating purchase orders and purchase records;
(d) accepting material delivered by suppliers and generating stock receipt records and material acceptance bills, if the delivery bills coincide with the purchase orders and a quality of the material is acceptable;
(e) reconciling data according to the purchase orders and the material acceptance bills, and generating data reconciliation records; and
(f) obtaining a new inventory data according to the current inventory and said stock receipt records.
